(19) United States
(12) Patent Application Publication
(10) Pub. No.: US 2008/0133726 A1
(43) Pub. Date: Jun. 5, 2008

(54) Network administration with guest access

(75) Inventors: Cyra Richardson, Bellevue, WA (US); Kynan Antos, Seattle, WA (US); Cesare Saretto, Seattle, WA (US); Charles Kindel, Bellevue, WA (US); Lee Linden, Bellevue, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/607,736

(22) Filed: Dec. 1, 2006

(51) Int. Cl. G06F 15/173

(52) U.S. Cl. 709/223

(57) ABSTRACT

An administrative system may include a screen with several administrative functions organized by user administrative functions, storage system management, computer management, and shared resource management. The administrative system for a computer network may enable a guest account to be set up across one or more computers on the network. The guest account may have some access to shared resources as well as an expiration date so that the guest account may become disabled and/or hidden after a specific time. The guest account may be created and managed through a progressive user interface.

### BACKGROUND

Computers are becoming an integral part of our society's home life. Many households have several computers. For example, a head of the household may use a first computer for managing finances while children in the home may use a separate computer for doing homework and communicating on the Internet. A third computer may be used in conjunction with an entertainment system for viewing television programming, movies, and audio entertainment. Similarly, many small businesses often have networks with just a few computers.

In a small network environment, administration of the network computers is often performed by a person with a minimal amount of computer training, if any. For users to get the benefit of a network, which include shared resources as well as common login procedures on several different computers, many administration tasks may need to be presented in a simplified, easy to understand format.

### SUMMARY

An administrative system may include a screen with several administrative functions organized by user administrative functions, storage system management, computer management, and shared resource management. The administrative system for a computer network may enable a guest account to be set up across one or more computers on the network. The guest account may have some access to shared resources as well as an expiration date so that the guest account may become disabled and/or hidden after a specific time. The guest account may be created and managed through a progressive user interface.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a pictorial illustration of an embodiment showing the architecture of a small network.

FIG. 2 is a pictorial illustration of an embodiment showing a user interface for administering a network.

FIG. 3 is a pictorial illustration of an embodiment showing a sequence of progressive user interfaces for establishing a guest account.

### DETAILED DESCRIPTION

Small networks, such as those found in a home or in a very small business, may be administered through a server that may establish user accounts, manage shared resources, and provide other administrative functions for the computers and storage devices on the network.

The user interface for the administrative functions may include various progressive user interfaces that combine some functions across the major areas of the administrative functions. In one such interface, a guest account may be created by putting in a user name and password, selecting the computers to which the guest may have access, and determine the extent of access the guest may have to various shared resources.

Specific embodiments of the subject matter are used to illustrate specific inventive aspects. The embodiments are by way of example only, and are susceptible to various modifications and alternative forms. The appended claims are intended to cover all modifications, equivalents, and alternatives falling within the spirit and scope of the invention as defined by the claims.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

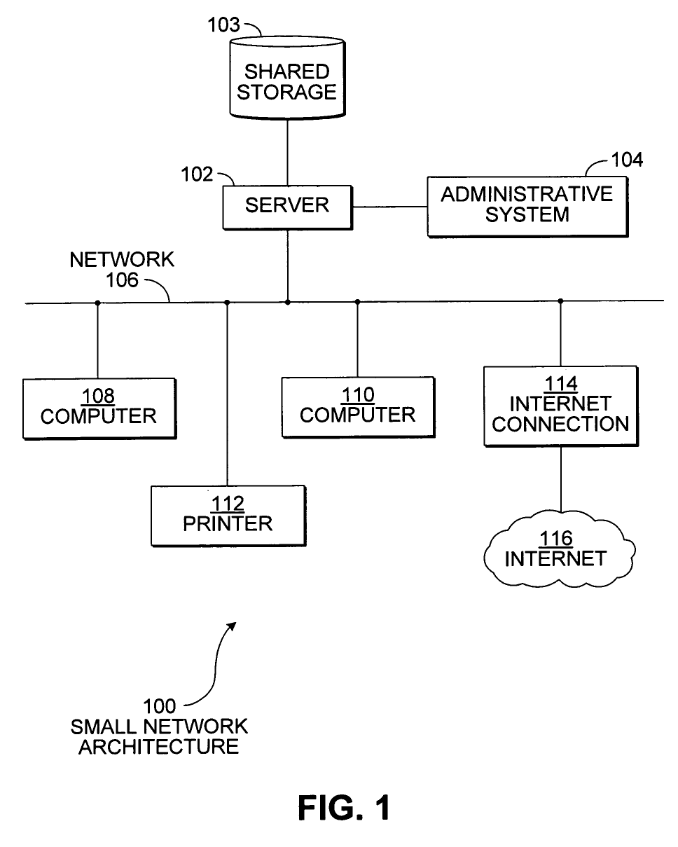

FIG. 1 is a diagram of an embodiment 100 showing a small network architecture. A server computer 102 has some shared storage 103 and an administrative system 104. The administrative system 104 may be a software application that is adapted to perform several administrative tasks across the network 106. Attached to the network 106 are also computers 108 and 110, as well as a printer 112 and an internet gateway 114 to the Internet 116. The internet gateway 114 may serve as a firewall.

The embodiment 100 illustrates a typical small local area network that may be found in a small business or home. In other embodiments, a network may have several servers and many devices attached to the network. The network 106 may be a wired or wireless network, and some embodiments may contain both wired and wireless connections. The devices attached to the network may include personal computer workstations, network appliances, mobile phone devices, personal digital assistants, remote control devices, or any other type of network accessible devices. For the purposes of illustration, an embodiment with three computers, one of which is a server, will be used in this specification.

The administrative system 104 may be an administrative software component that enables various functions to be performed. In some embodiments, the user interface for the administrative system 104 may be accessible through the server 102, while in other embodiments the user interface for the administrative system 104 may be accessible through any device attached to the network and, in some cases, through devices connected to the Internet 116.

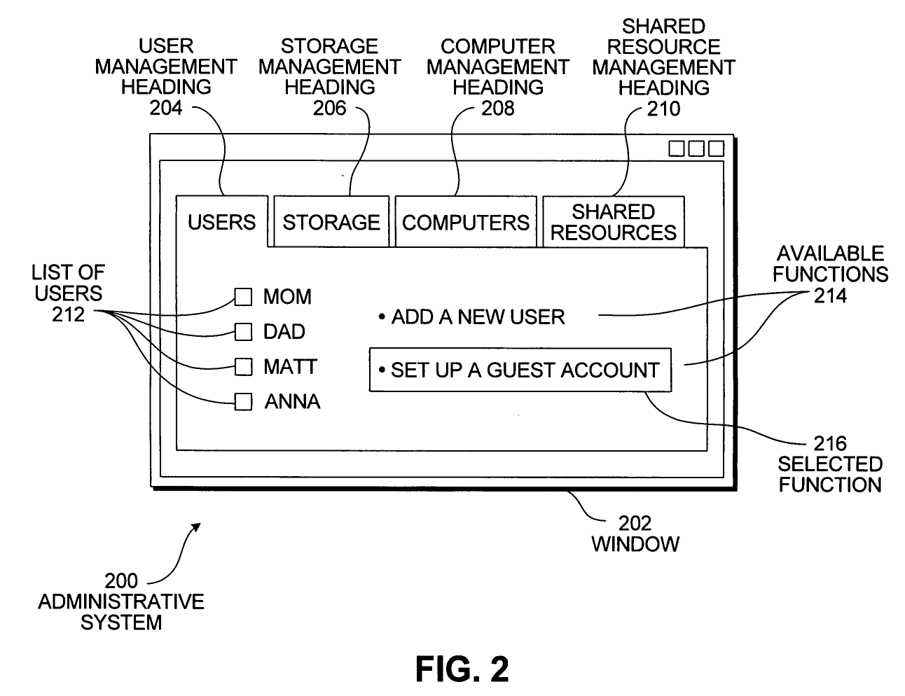

FIG. 2 is a pictorial illustration of an embodiment 200 showing a user interface for an administrative system. The window 202 comprises a user management heading 204, a storage management heading 206, a computer management heading 208, and a shared resource management heading 210.

In the present illustration, the user management heading 204 is selected and the user has an option to select one of the list of users 212 and modify a parameter associated with one of the users. Additionally, the user may select one of the available functions 214. In the present illustration, the user has selected the function 216, “Set up a guest account”.

The user management heading 204 may provide access to various settings, parameters, and functions associated with individual users. The storage management heading 206 may give access to functions, settings, and parameters associated with storage devices such as disk drives across the network. For example, the storage management heading 206 may include functions that relate to adding or removing hard disks, setting up and administering backup systems, and other associated functions.

The computer management heading 208 may include functions, parameters, and settings relating to the management of individual computers managed by the embodiment 200. Such functions may include installing and updating software, managing antivirus or other applications on the individual computers, monitoring the performance and usage of each computer, configuring and managing data backup systems, or other similar functions.

The shared resource management heading 210 may include various parameters, settings, and functions relating to files or devices that are shared over several computers. For example, shared resources may include printers, scanners, internet access, other computer systems, or other hardware devices or connections. Additionally, shared resources may include file systems or folders that are accessible from one or more computers. In some cases, shared file systems may be stored on a server computer, while in other cases shared file systems may be made available from individual computers.

In some embodiments, additional headings may be added. For example, a heading comprising email system administration, web services, or other major headings may be part of different embodiments. Each heading may provide a mechanism for performing various administrative functions for a major component of a network.

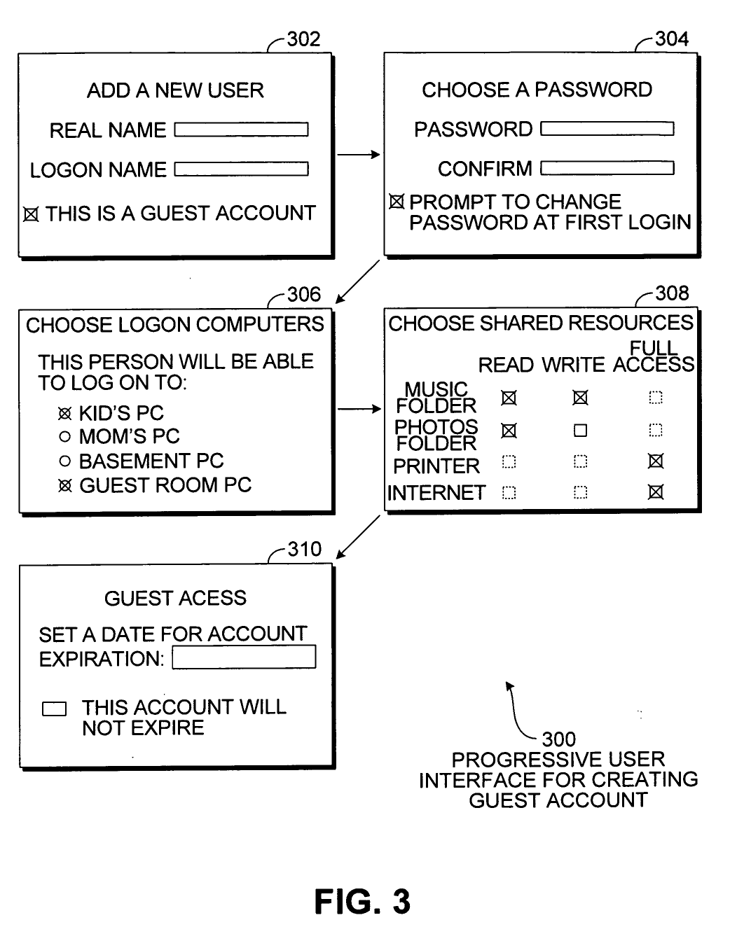

FIG. 3 illustrates an embodiment 300 showing a sequence of progressive user interface screens for creating a guest account. The embodiment 300 is one example of a progressive user interface that may be initiated by selecting the function 216, “Set up a guest account”. In screen 302, the administrator is asked to provide a real name and login name for the account. A box is checked indicating that the account will be a guest account.

In screen 304, a password is set for the account. A box is checked asking the user to change the password on the first login. In some instances, the administrator may not put in a password and the subsequent login may occur without a password.

In screen 306, the administrator may select one or more computers on which the new user will have access. In this example, the computers “Kid's PC” and “Guest room PC” are selected. Screen 306 is an example of how a progressive user interface may span two or more of the main headings within the user interface of embodiment 200. In this case, the progressive user interface gathers the settings under the user management heading 204, the computer management heading 206, and the shared resources heading 208.

Screen 308 shows several shared resources and the administrator is able to set the permissions for the new account across the resources. In the example, the new account has read and write access to the music folder, read access to the photos folder, and full access to the printer and internet resources. For each type of resource, different permissions may be set. Some embodiments may have different levels of access for internet access, such as unlimited access or various levels of monitored access, for example.

In screen 310, the administrator is asked to enter an expiration date for the guest account. An option is available to make the guest account not expire. In general, a guest account is one that will be available on the network for a short period of time. An example of when such an account would be useful is when a guest visits a home of a relative for friend for a few days, or when a client or vendor visits a company location for a temporary work assignment. In both examples, an administrator may wish to set up an account but not have to remember to disable access to the account after a period of time. By setting an expiration date, the account may be disabled, deleted, or otherwise unable to be accessed after a specific time and/or date. In some embodiments, the administrator may have the option to make the account hidden after the expiration date. Such a state may make the account inaccessible but keep the settings and any account-specific settings in place. Thus, when the account is desired in the future, it may be turned on without having to reestablish the settings.

A progressive user interface is a series of windows or separate user interfaces that gathers information to enable a function to be performed. Generally, a progressive user interface may be used to perform a very specific task that can be complicated to perform. One example of a progressive user interface is a wizard.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A server computer comprising:
a connection to a network;
a connection to a plurality of computers over said network;
shared resources accessible over said network;
a plurality of user accounts;
an administrative system adapted to provide a first progressive user interface for creating a guest account, said first progressive user interface comprising:
defining an optional password;
selecting shared resources;
determining at least one of said plurality of computers for guest access; and
determining an account expiration date.

2. The server computer of claim 1 wherein said network is a local area network.

3. The server computer of claim 2 wherein said network is connected to the Internet through a firewall.

4. The server computer of claim 1, shared resources comprising shared data folders.

5. The server computer of claim 1, shared resources comprising shared printers.

6. The server computer of claim 1, shared resources comprising shared connections to input devices.

7. The server computer of claim 1, said administrative system being further adapted to display a first window comprising links to administrative functions, said administrative functions comprising:
user account management;
storage management;
computer management; and
shared resource management.

8. The server computer of claim 1, said administrative system being accessible through one of said plurality of computers.

9. An administrative system comprising:
a connection to a plurality of computers over a network;
a connection to a server computer, said server computer comprising a user provisioning system and at least one shared resource;
said administrative system adapted to provide a first progressive user interface for creating a guest account, said first progressive user interface comprising:
defining an optional password;
selecting shared resources;
determining at least one of said plurality of computers for guest access; and
determining an account expiration date.

10. The administrative system of claim 9 wherein said network is a local area network.

11. The administrative system of claim 10 wherein said network is connected to the Internet through a firewall.

12. The administrative system of claim 9, shared resources comprising shared data folders.

13. The administrative system of claim 9, shared resources comprising shared printers.

14. The administrative system of claim 9, shared resources comprising shared connections to input devices.

15. The administrative system of claim 9 being further adapted to display a first window comprising links to administrative functions, said administrative functions comprising:
user account management;
storage management;
computer management; and
shared resource management.

16. The administrative system of claim 9 being accessible through one of said plurality of computers.

17. A method comprising:
presenting a first screen of a progressive user interface, said first screen having input for a password for a guest account within a network;
presenting a second screen of said progressive user interface, said second screen having input for determining access for said guest account on a plurality of computers on said network;
presenting a third screen of said progressive user interface, said third screen having input for determining access for said guest account to at least one shared resource available on said network; and
presenting a fourth screen of said progressive user interface, said fourth screen having input for determining an expiration time for said guest account.

18. The method of claim 17 further comprising:
displaying a first window comprising links to administrative functions, said administrative functions comprising:
user account management;
storage management;
computer management; and
shared resource management.

19. The method of claim 17 wherein said shared resources comprise at least one of shared folders and shared printers.

20. A computer readable medium comprising computer executable instructions adapted to perform the method of claim 17.
